(19) United States
(12) Patent Application Publication
(10) Pub. No.: US 2021/0251353 A1
(43) Pub. Date: Aug. 19, 2021

(54) IMPROVED UMBRELLA

(71) Applicant: INSIDE PRODUCTION, Cergy (FR)

(72) Inventor: Jacques COLSON, Auvers-sur-Oise (FR)

(21) Appl. No.: 17/256,273

(22) PCT Filed: May 29, 2019
(86) PCT No.: PCT/EP2019/064064

§ 371 Date: Mar. 16, 2021

(30) Foreign Application Priority Data
Jun. 29, 2018 (EP) 18305842.9

(51) Int. Cl. A45B 25/18; A45B 11/02; A45B 19/02; A45B 25/14; F04B 37/10; G02F 1/01; H02S 30/20; H02S 30/10

(52) U.S. Cl. CPC A45B 25/18; A45B 11/02; A45B 19/02; A45B 25/143; F04B 35/04; G02F 1/0126; H02S 30/20; H02S 30/10; A45B 2025/183; F04B 37/10

(57) ABSTRACT

An umbrella comprises a frame, a set of cloths extending over the frame, a gripping structure for carrying the umbrella in the open position, at least one of the cloths of the set of cloths comprising structure for treating solar radiation.

### TECHNICAL FIELD OF THE INVENTION

The invention relates to improvements made to umbrellas and similar devices.

### PRIOR ART

At the present time, existing umbrellas comprise, in a first family, a collapsible frame, for example a metal frame. One disadvantage with this first family stems from the fact that it is necessary to reach a compromise between a solution that is lightweight but not very strong and a solution that is more reliable, but bulky. Specifically, lightweight umbrellas have a tendency to turn inside-out in the wind, and more robust umbrellas are generally bulkier, either because they are longer, or because the frame is fragile. In addition, the design of such umbrellas does not lend itself to offering particular shapes other than the generally-known shape of a cone of which the very open angle affords protection from the rain while removing the rainwater via the edges of the canopy.

An existing second family of umbrellas relates to inflatable umbrellas. These are lightweight and their inflated shape is generally resistant to wind. Furthermore, absolutely any shape can be offered because there is no folding mechanism to dictate particular umbrella dynamics. By contrast, they have a disadvantage that makes their use less attractive: they have to be inflated prior to use. One solution to this disadvantage is described in document FR 3 051 637.

However, such umbrellas do not offer their user optimum comfort, particularly with regard to brightness and the use of any electrical and/or electronic equipment that the umbrella might have.

### SUMMARY OF THE INVENTION

It is an object of the invention to provide an umbrella which offers greater comfort of use.

To this end, the invention provides an umbrella comprising a frame, a collection of canopy-forming panels extending over the frame, a grip for carrying the umbrella in the open position, at least one of the panels of the canopy of panels comprising means for treating solar radiation.

Advantageously, but optionally, the umbrella according to the invention exhibits at least one of the following technical features:
the means for treating solar radiation are sandwiched between two films that form at least one of the panels of the canopy of panels;
the means for treating solar radiation comprise a photochromic film;
the photochromic film is positioned at a panel situated in front of a user of the umbrella;
the photochromic film is positioned at a panel that forms a top of the umbrella;
the photochromic film is positioned at all of the panels that make up the canopy;
the means for treating solar radiation comprise a photovoltaic film;
the photovoltaic film is positioned at a panel situated behind of a user of the umbrella;
the photovoltaic film is positioned at a panel that forms a top of the umbrella;
the umbrella comprises a means for hands-free carrying of the umbrella in the open position;
the means for the hands-free carrying of the umbrella comprises a shoulder rest;
the umbrella comprises a obstacle detection means;
the obstacle detection means is a camera;
the frame is an inflatable frame; and
the umbrella comprises an activatable microcompressor arranged in such a way as to inject a volume of air into the inflatable frame.

### BRIEF DESCRIPTION OF THE FIGURES

Further features and advantages of the invention will become apparent from reading the following description of one embodiment of the invention. In the attached drawings:

FIG. 1 is a three dimensional view of an umbrella according to the invention, in the open position and carried by a user;

FIG. 2 is a three dimensional view of the umbrella according to one embodiment of the invention;

FIG. 3 is a side view of a grip element of the umbrella according to the invention;

FIG. 4 is a partial three dimensional view of a grip element held in the umbrella according to the invention;

FIG. 5 is a partial three dimensional view of a grip element fixed to a lower part of the umbrella according to the invention;

FIG. 6 is a partial side view illustrating one example of a grip element comprising an activatable button for initiating inflation of the umbrella according to the invention via a movement of the thumb;

FIG. 7 is a three dimensional view of the umbrella according to a variant embodiment of the invention; and

FIG. 8 is a three dimensional view of the umbrella according to another variant embodiment of the invention.

For greater clarity, elements that are identical or similar are identified in all of the figures by identical reference signs.

### DETAILED DESCRIPTION OF ONE EMBODIMENT

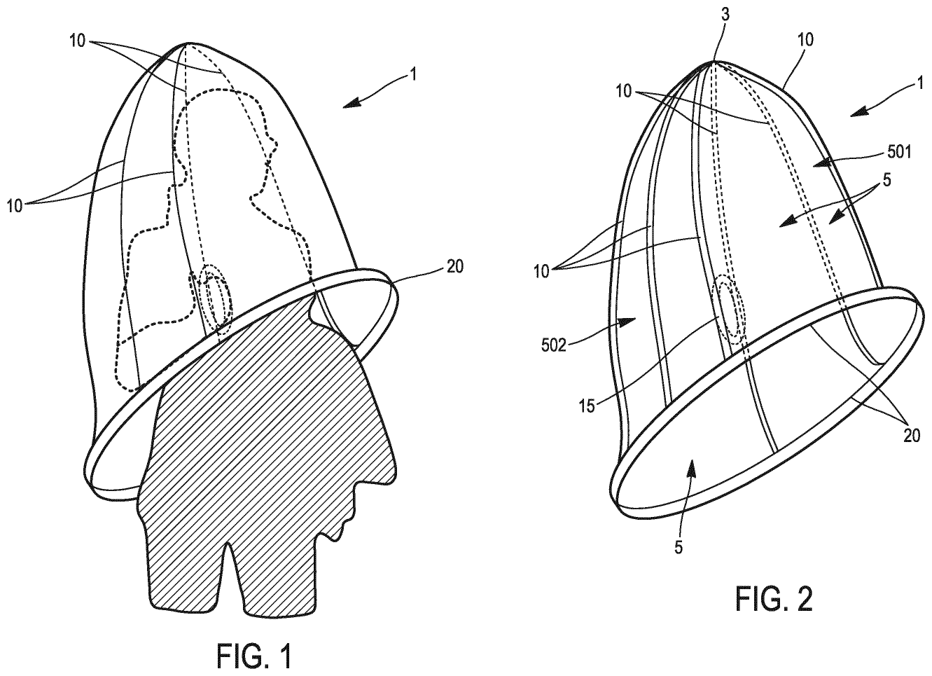

Reference is made to FIG. 1 which depicts one embodiment of an umbrella 1 according to the invention, in an open position and carried by a user. The umbrella 1 according to the invention has, in this open position, an ogive shape that allows a user to immerse him or herself in a dry environment and affording protection against rain, wind and also hail. It is possible for the umbrella 1 according to the invention to exhibit different shapes, at least in the open position. However, according to these different embodiments, the overall shape of the umbrella 1 according to the invention is compatible with a convex shape forming rounded portions on the exterior surface of the umbrella.

The umbrella 1 according to the invention is, in this instance, an inflatable umbrella. Such an inflatable umbrella makes it possible to offer a wide variety of shapes to meet criteria of taste, design, or aerodynamic shape in order to distance as effectively as possible the drops of rain that bounce off the umbrella 1 according to the invention in the open position. The umbrella 1 according to the invention as illustrated in FIG. 1 represents an embodiment of which the shape offers elegance, a practical appearance, and good protection. This umbrella is described in detail in document FR 3 051 637 to which reference can be made for further information. However, for the sake of better understanding, some of this information is recalled hereinbelow.

The umbrella 1 according to the invention comprises, in the inflatable version illustrated here, an inflatable base 20 acting as a circumferential frame, and inflatable arches 10, also referred to as bows 10, and forming something akin to meridians on the structure of the umbrella 1 according to the invention in the inflated open position. The bows 10 act as longitudinal frame elements extending between the base 20 and a top 3 of the umbrella 1 according to the invention.

According to one embodiment, at least one arc is formed of a rigid arc 101 comprising a grip 15. The rigid arc 101 may be tubular in shape, with a circular or ellipsoidal cross section. According to another embodiment, the rigid arc 101 has a U-shaped cross section.

The collection of bows 10 and of the base 20 may form a single air chamber. In that embodiment, the bows 10 each comprise a junction that allows a volume of air to circulate between them and with the base 20. In a first variant, the air circulates between the bows via the top 3.

According to a second variant, the air circulates between the bows via their junction with the base 20. In this latter instance, the air circulates between each arc 10 and the base 20, the base 20 forming a common air-passage element for inflating and deflating the umbrella 1 according to the invention.

According to various embodiments, the umbrella 1 according to the invention may comprise a given number of bows 10. The number of bows 10 is chosen to offer a structure that is robust, harmonious, and able to define an interior space which is as pleasant as possible for a user. The presence of the rigid arc 101 stiffens the structure and makes it possible for the umbrella 1 according to the invention to maintain an overall shape, particularly at the point via which the user is holding it.

According to a variant embodiment, the rigid arc 101 is a telescopic arc which can be extended via a specific action on the part of the user.

According to an embodiment illustrated in FIG. 2, the umbrella 1 according to the invention comprises a collection of canopy-forming panels 5 of which at least one panel is transparent. According to a variant embodiment, all the panels of the canopy of panels 5 are opaque so as to form a sunshade. The invention therefore relates to a sunshade, in addition to relating to an umbrella. In the remainder of the description, the example of an umbrella is detailed, although all the aspects of the invention apply equally to the sunshade.

The collection of canopy-forming panels 5 forms an overall canopy that dictates the overall shape of the umbrella 1 according to the invention when in the open position. To this end, according to one embodiment, the panels of the canopy of panels 5 are assembled in such a way as to form a single canopy. Assembly can be achieved in various ways such as, for example, by adhesive bonding or by fusion bonding or by electrofusion welding.

The overall canopy covers the entirety of the umbrella 1 according to the invention and connects the bows 10, 101 with one another and with the base 20. The bows 10, 101 are connected together at the top 3 of the bows 10, 101 and are joined to the base 20.

The overall canopy formed by the collection of panels 5 is arranged in such a way that each of the panels of the canopy of panels 5 is assembled between two adjacent bows 10 and the base 20. This assembly is performed for example by electrofusion welding to the bows 10, 101 or to the base 20.

According to a variant embodiment, the canopy of panels 5 of the umbrella 1 according to the invention is manufactured by superposing two fusion-bonded panels or films. It can be manufactured in a single piece or several pieces. During the operation of fusion bonding the two panels or films to one another, rigid longitudinal elements, also referred to as pre-positioning rods, are inserted between the two panels in order to form the inflatable bows 10. These are then removed to leave an air volume. In such a case, the inflatable bows 10 are formed by the superposition of two films leaving a longitudinal gap along the panel to more or less form a channel.

According to a variant embodiment, the umbrella 1 according to the invention has an overall shape exhibiting symmetry about an axis of revolution. According to another variant embodiment, the umbrella 1 according to the invention exhibits a shape having asymmetries about an axis of revolution. Such is the case with the umbrella depicted here in the figures.

The asymmetry of this latter variant embodiment makes it possible to define a frontal part 501, that forms the front of the umbrella 1 and a part 502 that forms the back.

The frontal part of the umbrella 1 according to the invention is denoted 501 in FIG. 2. It therefore corresponds to the front of the umbrella 1 according to the invention, namely to the part that will be facing the head of a user walking along holding the umbrella 1 according to the invention. This part is preferably transparent, at least partially, so that a user can see through the panel that forms the part 501 and thus avoid obstacles or other passers-by.

According to a variant embodiment, the overall canopy is fully transparent.

According to one embodiment of the invention, at least one of the panels of the canopy of panels 5 comprises means for treating solar radiation.

According to a first variant embodiment, the means for treating solar radiation comprise a photochromic film positioned on that or those of the panels of the canopy of panels 5 that is or are transparent. That allows light passing through this or these transparent panel(s) to be filtered dynamically, namely according to the brightness, in order to improve the visual comfort of the user of the umbrella 1 according to the invention. In particular, the panel forming the transparent front part 501 comprises such a photochromic film in this variant embodiment of the umbrella 1 according to the invention. In another variant embodiment, the umbrella 1 according to the invention comprises a top panel 503 of the canopy of panels 5 extending around the top 3 of the umbrella 1 according to the invention. This top panel 503 is connected to the other panels of the canopy of panels 5 by an assembly 504 achieved in various ways such as, for example, by adhesive bonding or by fusion bonding or by electrofusion welding. The top panel 503 comprises the photochromic film. In yet another variant embodiment, in which all of the panels of the canopy of panels 5 are transparent, the photochromic film is positioned in all of these panels.

In instances in which the panels are formed by a superposition of two fusion bonded panels or films, the photochromic film that forms the means for treating solar radiation is sandwiched between the two films or panels.

According to a second variant embodiment, the means for treating solar radiation comprise a photovoltaic film. The photovoltaic film comprises a layer of photovoltaic cells which may be attached to a panel or film which may or may not be transparent. This makes it possible to have a source of energy to power any electrical and/or electronic equipment with which the umbrella 1 according to the invention might be equipped. In particular, the panel 502 forming the transparent or non-transparent rear part of the umbrella 1 according to the invention comprises such a photovoltaic film in this variant embodiment of an umbrella 1 according to the invention. In another variant embodiment, the umbrella 1 according to the invention comprises a top panel 503 of the canopy of panels 5. This top panel 503 is connected to the other panels of the canopy of panels 5 by an assembly 504 achieved in various ways such as, for example, by adhesive bonding or by fusion bonding or by electrofusion welding. The top panel 503 contains the photovoltaic film.

Once again, in the case where the panels are formed by superposing two fusion bonded panels or films, the photovoltaic film that forms the means for treating solar radiation is sandwiched between the two films or panels, it being understood that the outer film or panel is transparent so that the light can reach the photovoltaic film.

According to one variant embodiment, the umbrella 1 according to the invention is designed to exhibit a shape that extends below the level of the shoulders or even the chest of an individual.

The grip element 15 of the umbrella 1 according to the invention will now be described.

According to a first embodiment, the grip element 15 is fixed to one 101 of the arches 10, 101 of the umbrella 1 according to the invention. The grip element 15 is, in this instance, arranged near the base 20 so as to benefit from the stiffness of the structure at the level of its circumferential base 20.

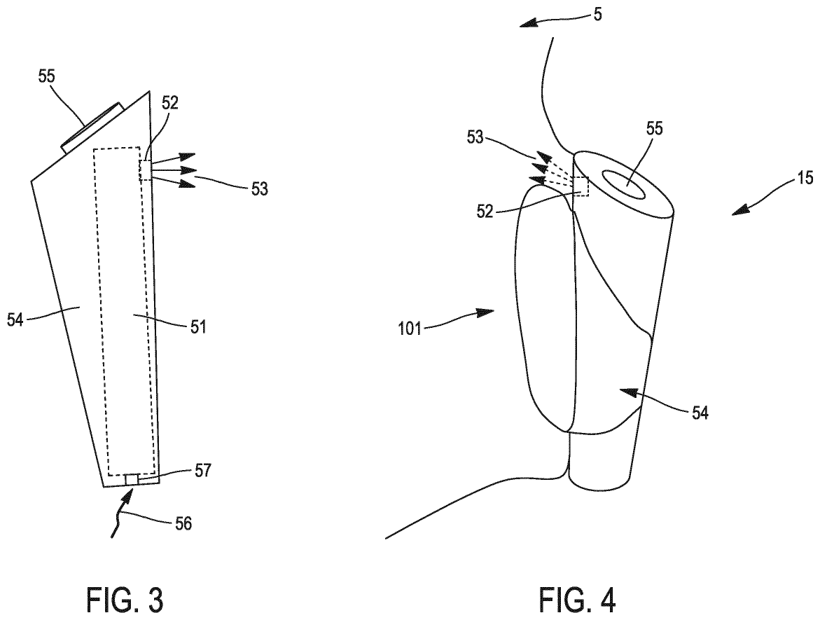

Illustrated here, the grip element 15 comprises a casing 54 inside which a microcompressor 51 is arranged. FIG. 3 provides a depiction of one embodiment of such a grip element 15. The grip element 15 forms a hand grip and may therefore be designed to be able to be grasped in the hand.

According to a variant embodiment, the grip element 15 comprises a casing 54 comprising a grip. The grip element 15 may be defined as being an element of substantially cylindrical shape which has rough parts or a geometry designed to be held in a hand.

The grip element 15 may comprise an opening (not depicted) and a first housing to accommodate a microcompressor 51. The opening allows the insertion of the microcompressor 51. A first cap may be provided in order to keep the grip element 15 inside the casing 54.

A power supply for the microcompressor 51 is incorporated into the grip element 15, inside the casing 54. In a variant, a second housing in the casing 54 is designed into which to insert the power supply for the microprocessor 51. The second housing may be accessible via an opening comprising, for example, a removable second cap. Alternatively, the microcompressor 51 and its power supply can both be arranged inside the one same housing via a single opening. The power supply may be a rechargeable battery, or cells.

In the case of a power supply comprising rechargeable batteries, these may be electrically connected to the photovoltaic cells of the photovoltaic film that forms the means for treating solar radiation provided in at least one of the panels of the canopy of panels 5, as described previously.

Furthermore, the casing 54 of the grip element 15 forms a cylinder which, in this instance, comprises a first lateral opening 52 for expelling a volume of air 53 from the microcompressor 51. The lateral opening of the casing in this instance in FIGS. 3 and 4 coincides with the air outlet 52 of the microcompressor. The two outlets are designed to cooperate or be in fluidic connection with one another. Furthermore, it comprises a second opening 57 coinciding with the external air pumping intake 57 of the microcompressor 51.

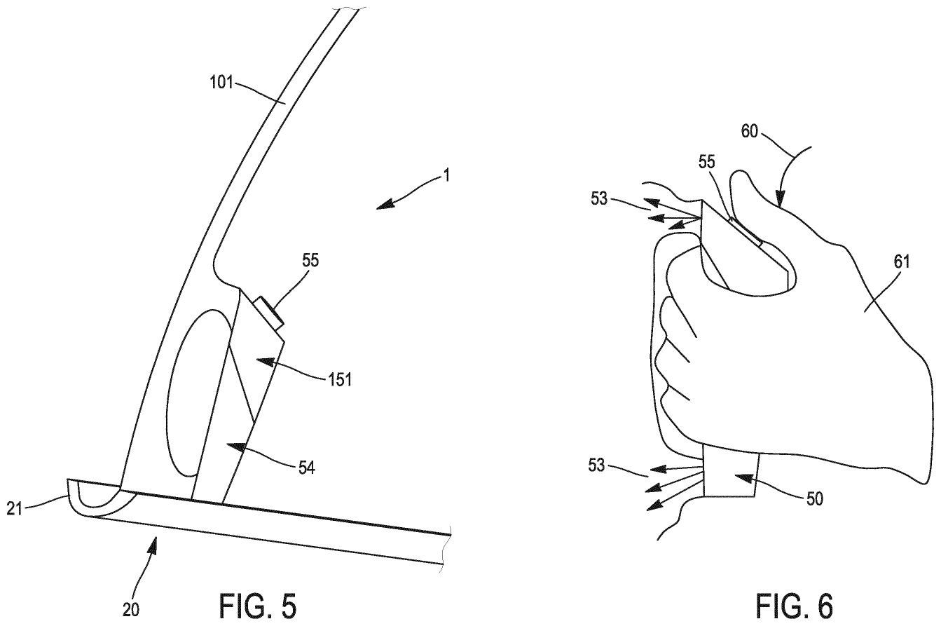

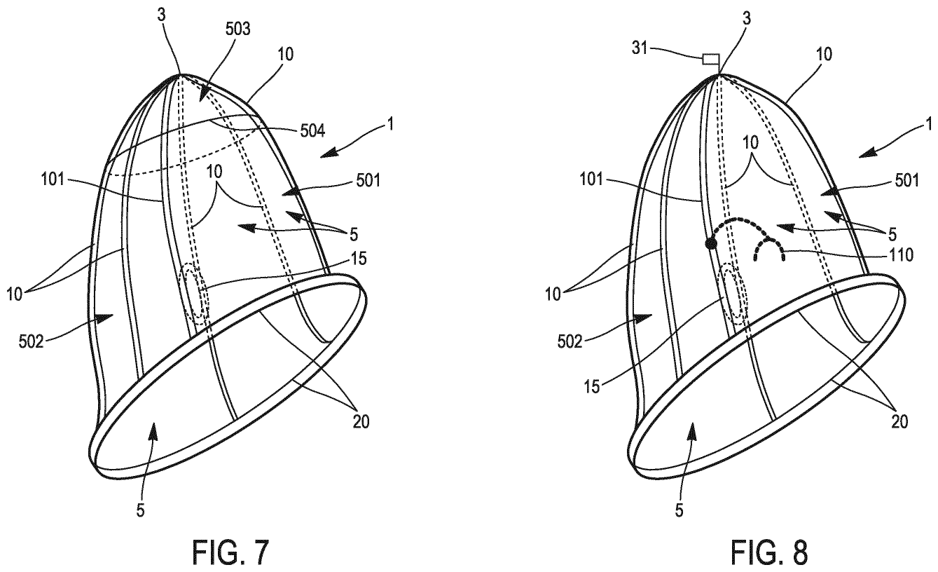

In the foregoing, the small-sized microcompressor 51 is incorporated into the grip element 15 as depicted in FIGS. 3, 4, 5 and 6. According to another embodiment, the microcompressor 51 is incorporated into the rigid arc 101. It may for example be arranged in the portion of the arc that extends between the lower end and the grip element 15.

The microcompressor 51 comprises an air intake 57 allowing it to pump in a volume of air 56 and compress same so that it can be injected into the inflatable part of the umbrella 1 according to the invention, via the air outlet 52. A volume of air 53 is then able to inflate the umbrella 1 according to the invention in a short space of time.

According to another embodiment, the microcompressor 51 is twinned with a compressed-air capsule. An interface between the microcompressor 51 and the capsule allows activation of the air intake of the capsule for injection into the air chamber, formed of the inflatable bows 10 and of the base 20. According to one embodiment, the capsule is movable and interchangeable. A compartment, either of the casing 54 of the grip element 15 or of the rigid arc 101, provides access to the capsule so that it can be changed once it is empty. According to another embodiment, the capsule can be refilled using the pumping function of the microcompressor 51.

The microcompressor 51 may comprise an activation control allowing pumping, compression and the generation of an air flow 53 to be engaged automatically. According to one embodiment, a button 55 allows the activation command to be engaged by simply pressing the button.

FIG. 6 depicts the grip element 15 held in a hand 61. A movement of the thumb of the hand 61 on the button 55 engages generation of an air flow 53 expelled from the microcompressor 51 toward the inflatable part 10, 20 of the umbrella 1 according to the invention. Illustrated here, two air outlets allow a volume of air 53 to be ejected into the inflatable part 10, 20 of the umbrella 1 according to the invention.

According to one embodiment, the casing 54 comprises an upper part comprising a button 55 for activating the button of the microcompressor 51. According to another embodiment, the button of the microcompressor 51 cooperates with an opening of the casing 54 to leave the button 55 visible. The casing 54 further comprises at least a first lateral opening 52 for expelling the pumped and compressed air 53, and at least a second opening 57 for pumping in ambient air 56. The openings in the casing 54 cooperate with those of the microcompressor 51.

According to another embodiment, when the umbrella 1 according to the invention comprises a rigid arc 101, it comprises at least one button 55 or an actuator to activate the microcompressor 51 in order to engage the inflating of the umbrella 1. According to one embodiment, the rigid arc 101 comprises at least one opening for the passage of a button of the microcompressor which is directly accessible thereon. The rigid arc 101 possibly comprises at least a first lateral opening to expel the pumped and compressed air into the air chamber 10, 20. According to one embodiment, at least one second opening may be provided for pumping in ambient air 56 when no capsule is needed. In the event that a capsule is used, the microcompressor is incorporated into the rigid arc with the capsule. The actuator engaging inflation therefore leads to intake of air from the capsule by the microcompressor. In a hybrid embodiment, the microcompressor 51 comprises one intake for drawing air from the capsule and one air intake for drawing in ambient air.

According to a variant embodiment, the microcompressor comprises an electrically operated valve.

Illustrated in FIG. 8, one embodiment of the umbrella 1 according to the invention comprises a means 110 for the hands-free carrying of the umbrella in the open position. That allows the user of the umbrella 1 according to the invention to carry it while having both hands free for performing other activities, all the while remaining protected by the umbrella 1 according to the invention. In one embodiment, the means 110 comprises a shoulder rest which is deployable in the position of use and which is positioned on the shoulders of the user. To this end, this shoulder rest is mounted with the ability to rotate at the end of an arm on the rigid arc 101 of the umbrella 1 according to the invention. When not in use, the shoulder rest is folded against the rigid arc 101 where it can be stowed.

Optionally, the umbrella 1 according to the invention comprises an obstacle detection means. For example, illustrated here, the obstacle detection means is a camera 31 situated at the top 3 of the umbrella 1 according to the invention. In a variant embodiment, the obstacle detection means may be proximity radars/sensors positioned on the umbrella 1 according to the invention, for example on the periphery formed by the circumferential frame 20 and/or on the bows 10, 101. The obstacle detection means further comprises a processing and warning unit connected to the camera 31 or to the proximity radars/sensors. The obstacle detection means is powered by a rechargeable battery and/or by the photovoltaic cells of the photovoltaic film that forms the means for treating a solar radiation provided in at least one of the panels of the canopy of panels 5, as was described earlier.

The invention overall has been illustrated and described with reference to an inflatable umbrella like the one described in document FR 3 051 637. However, the invention as claimed also applies to traditional umbrellas with a collapsible mechanical frame, such as a metal frame. It also applies to similar devices such as sunshades.

Among the additional electrical and/or electronic equipment that can be incorporated into the umbrella 1 according to the invention, this umbrella comprises:
a wireless interface for pairing a wireless electronic device such as a mobile telephone, a tablet, a digital personal assistant or any other similar electronic device. Thus, for example, the umbrella 1 according to the invention may transmit state parameters, such as an inflated/deflated state, so that the electronic device activates a data transfer function. An authentification mechanism may be provided.
an audio output and/or an image output. The image output may be a display in the form of a flexible screen incorporated into an internal face of the overall canopy of the umbrella according to the invention. In a variant, the display is a portion of the overall canopy that is rendered opaque and non-transparent and onto which a projector displays an image, the projector being able to be incorporated into the umbrella 1 according to the invention.
a device for treating the air contained in an internal volume delimited by the overall canopy, with the umbrella 1 according to the invention in the open position. The air treatment device offers filtration and/or temperature regulation and/or humidity regulation functions.
one or more light sources, such as light emitting diodes.
etc.

In order to control the operation of the various electronic and/or electrical equipment items with which the umbrella 1 according to the invention is equipped, this umbrella further comprises a processing and control unit comprising a processor connected to a memory and running control and processing software for executing the various functions of the electronic and/or electrical equipment.

In general, the various electronic and/or electrical equipment items with which the umbrella 1 according to the invention is equipped, and also the processing and control unit, are powered by rechargeable batteries provided in the umbrella 1 according to the invention and/or by the photovoltaic cells of the photovoltaic film that forms the means for treating solar radiation provided in at least one of the panel of the canopy of panels 5, as described earlier.

Of course, it is possible to make numerous modifications to the invention without thereby departing from the scope thereof.

1. An umbrella comprising a frame, a collection of canopy-forming panels extending over the frame, a grip for carrying the umbrella in the open position, wherein at least one of the panels of the canopy of panels comprises means for treating solar radiation.

2. The umbrella as claimed in claim 1, wherein the means for treating solar radiation are sandwiched between two films that form at least one of the panels of the canopy of panels.

3. The umbrella as claimed in claim 1, wherein the means for treating solar radiation comprise a photochromic film.

4. The umbrella as claimed in claim 3, wherein the photochromic film is positioned at a panel situated in front of a user of the umbrella.

5. The umbrella as claimed in claim 3, wherein the photochromic film is positioned at a panel that forms a top of the umbrella.

6. The umbrella as claimed in claim 3, wherein the photochromic film is positioned at all of the panels that make up the canopy.

7. The umbrella as claimed in claim 1, characterized in that the means for treating solar radiation comprise a photovoltaic film.

8. The umbrella as claimed in claim 7, wherein the photovoltaic film is positioned at a panel situated behind of a user of the umbrella.

9. The umbrella as claimed in claim 7, wherein the photovoltaic film is positioned at a panel that forms a top of the umbrella.

10. The umbrella as claimed in claim 1, comprises a means for hands-free carrying of the umbrella in the open position.

11. The umbrella as claimed in claim 10, wherein the means for the hands-free carrying of the umbrella comprises a shoulder rest.

12. The umbrella as claimed in claim 1, comprises an obstacle detection means.

13. The umbrella as claimed in claim 12, wherein the obstacle detection means is a camera.

14. The umbrella as claimed in, wherein the frame is an inflatable frame.

15. The umbrella as claimed in claim 14, comprises an activatable microcompressor arranged in such a way as to inject a volume of air into the inflatable frame.
